(19) United States
(12) Patent Application Publication
(10) Pub. No.: US 2025/0138916 A1
(43) Pub. Date: May 1, 2025

(54) AUTOMATED NAMING MANAGEMENT FOR APPLICATION PROGRAMMING INTERFACES

(71) Applicant: Dell Products L.P., Round Rock, TX (US)

(72) Inventors: Shailesh Sharma, Morris Plains, NJ (US); Guerrero Ariel, San Antonio, TX (US); Ashok K. Muthukrishnan, Prosper, TX (US); Venkata Satya Patelkhana, Round Rock, TX (US); Prathap Mare, Hyderabad (IN)

(21) Appl. No.: 18/495,309

(22) Filed: Oct. 26, 2023

(51) Int. Cl. G06F 9/54

(52) U.S. Cl. CPC G06F 9/543

(57) ABSTRACT

Techniques are disclosed for application programming interface management in information processing systems. For example, a method comprises obtaining one or more data sets descriptive of at least one application programming interface, and automatically generating a name for the at least one application programming interface, wherein the name comprises a naming format applied across a plurality of application programming interfaces searchable by names.

### FIELD

The field relates generally to information processing systems, and more particularly to techniques for application programming interface management in such information processing systems.

### BACKGROUND

Enterprises with complex information technology (IT) systems are configured to execute or otherwise enable execution of a multitude of different types of applications and/or microservices (more generally, computer programs) including, by way of example only, cloud, software-as-a-service (SaaS), customer relationship management (CRM), enterprise resource planning (ERP), custom, emerging, etc. Such applications and/or microservices often have to communicate with one another. An application programming interface (API) is a way for two or more computer programs to communicate using a standardized software interface that is typically described in a document called an API specification. However, given the multitude of applications and/or microservices associated with an enterprise, managing the corresponding multitude of APIs presents significant technical challenges.

### SUMMARY

Illustrative embodiments provide techniques for application programming interface management in information processing systems.

For example, in one or more illustrative embodiments, a method comprises obtaining one or more data sets descriptive of at least one application programming interface, and automatically generating a name for the at least one application programming interface, wherein the name comprises a naming format applied across a plurality of application programming interfaces searchable by names.

In some illustrative embodiments, automatic generation of a name for at least one application programming interface includes a method which comprises extracting one or more named entities from the one or more data sets, and filtering the extracted one or more named entities to obtain a filtered set of one or more named entities. The method further comprises determining an intent result from the one or more data sets. The method still further comprises assembling the filtered set of one or more named entities and the intent result into the name for the at least one application programming interface.

Advantageously, some illustrative embodiments generate standardized API names which are intuitive and accurately convey API functionality, as well as enable automatic publishing of API names via an API development portal, validation of API names during the publishing phase and repair of broken (e.g., vague, misleading, grammatically incorrect, etc.) legacy API names through an edit API name feature. Some illustrative embodiments also enable a bulk repair feature where legacy API names can be repaired in bulk.

These and other illustrative embodiments include, without limitation, methods, apparatus, networks, systems and processor-readable storage media.

### BRIEF DESCRIPTION OF THE DRAWINGS

FIG. 1 illustrates an information processing system environment configured with automated application programming interface name generation/edit functionalities according to an illustrative embodiment.

FIG. 2 illustrates an architecture for an automated application programming interface naming generator/editor according to an illustrative embodiment.

FIGS. 3A-3C illustrate exemplary program code associated with an automated application programming interface naming generator/editor according to illustrative embodiments.

FIGS. 4A and 4B illustrate automated application programming interface name generation/edit methodologies according to illustrative embodiments.

FIGS. 5 and 6 illustrate examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, processing systems comprising compute, storage and/or network resources, other types of processing systems comprising various combinations of physical and/or virtual resources, as well as other types of distributed computer networks.

As mentioned, management of APIs presents significant technical challenges to an enterprise or any entity that maintains IT systems with a constantly growing number of APIs. By way of example only, some enterprises may have thousands of APIs across production and non-production systems. In some cases, APIs and their corresponding API specifications (descriptions) are published such that the API can be searched and subscribed to using an API developer portal made available, for example, by an enterprise to employees, customers, consumers and/or any other stakeholders (more generally, users). More particularly, after an API and specification are successfully published on the API developer portal, the API can be searched by a user before the user subscribes to and uses the API. Searching for an API using an API name is a critical function for a subscriber. Thus, it is realized herein that the quality of API names is important. To provide consistent user experience across many APIs, it can be useful for API names to be simple, intuitive and consistent. Currently, however, many API names used in API developer portals are vague/ambiguous and do not accurately convey the functionality of the API. For example, in an existing API developer portal, e.g., an API for a cloud snapshot manager application used for a production system may vaguely be named by the developer as csm_PRD, or worse, the intended acronym could accidentally have transposed letters, scm_PRD. A search by a user with terms such as cloud, snapshot, or manager, would not likely return the API for the cloud snapshot manager application.

Thus, with current approaches, API names and descriptions for different APIs may be the same, or descriptions may be missing or ambiguous. In addition, with conventional techniques, many API names do not follow any context and/or lack proper grammar. As a result, API users are confused and/or misinformed, making important APIs difficult to find and leading to redundant build efforts that waste critical application resources, impose unnecessary development costs and reduce efforts to maximize API re-usability.

To address the above and other technical problems, illustrative embodiments provide techniques to automatically generate standardized API names which are intuitive and accurately convey API functionality. Advantageously, illustrative embodiments enable automatic publishing of API names via an API development portal, validation of API names during the publishing phase and repair of broken (e.g., vague, misleading, grammatically incorrect, etc.) legacy API names through an edit API name feature. Illustrative embodiments also enable a bulk repair feature where legacy API names can be repaired in bulk.

By way of example, according to one or more illustrative embodiments, API names can be automatically generated with the following standardized format: <Capability/Functionality Name>. In addition, in some illustrative embodiments, <Product Name> and/or <Enterprise Domain> can be added to the API name, e.g., <Capability/Functionality Name> <Product Name> <Enterprise Domain>.

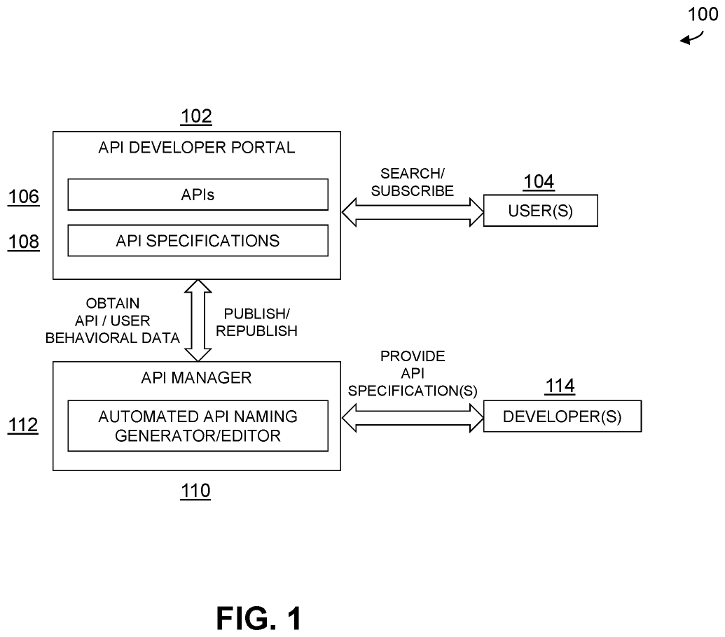

Referring initially to FIG. 1, an information processing system environment 100 configured with automated application programming interface (API) name generation/edit functionalities is depicted according to an illustrative embodiment. As shown, information processing system environment 100 comprises an API developer portal 102 configured to enable one or more users 104 (e.g., employees, customers, consumers, developers, and/or any other enterprise stakeholders) to access APIs 106 and their corresponding API specifications 108 for applications, microservices and/or other computer programs that an enterprise or other entity supplies or otherwise makes available to the one or more users 104. As mentioned, an enterprise publishes APIs 106 and their corresponding API specifications 108 and the one or more users 104 can search for the API 106 using API developer portal 102. It is to be appreciated that the content of each one of API specifications 108 are dependent on the specific functionality of the corresponding one of APIs 106 that it describes and can include, but is not limited to, natural language descriptions about the API, valid query parameters for the API, valid operator values for the API, etc.

However, as mentioned with respect to existing API developer portals, APIs with vague, misleading and/or grammatically incorrect names can result in redundant efforts that waste critical application resources, impose unnecessary development costs and reduce efforts to maximize API re-usability. As such, information processing system environment 100 further comprises an API manager 110 configured with an automated API naming generator/editor 112 which, inter alia, generates names for new APIs, based on API specifications provided by one or more developers 114, having a standardized format which is clear, non-misleading and grammatically correct such as, by way of example only: <Capability/Functionality Name> followed by <Product Name> followed by <Enterprise Domain>. Other embodiments contemplate alternative standardized API naming formats and thus it is to be understood that automated API naming generator/editor 112 is not limited to a specific format. Further, in some embodiments, formats of names suggested by automated API naming generator/editor 112 can be added, deleted, or modified by a developer before they are published to API developer portal 102.

Additionally or alternatively, automated API naming generator/editor 112 is configured to edit (repair) names for existing APIs to have the standardized format. As will be further explained, editing existing names can be based at least in part on behavioral data collected for the subject one of APIs 106 and/or from behavioral data collected from the one or more users 104 with respect to the subject one of APIs 106. Similarly, formats of edited names suggested by automated API naming generator/editor 112 can be added, deleted, or modified by a developer before they are republished to API developer portal 102.

Advantageously, automated API naming generator/editor 112 provides a self-learning and validation framework so that the one or more developers 114 can have their APIs named or re-named according to a standardized format. Automated API naming generator/editor 112 further provides the capability to validate and/or re-validate a given API name with configured patterns and provide suggestions accordingly to the one or more developers 114. For example, in some embodiments, automated API naming generator/editor 112 comprises an artificial intelligence/machine learning (AI/ML) solution to self-train various patterns and achieve robustness over a period, while adhering to industry and/or enterprise standards. Such AI/ML solutions can also learn organization/department-level specifications of the enterprise to suggest an API name that reflects such organization/department-level specifications.

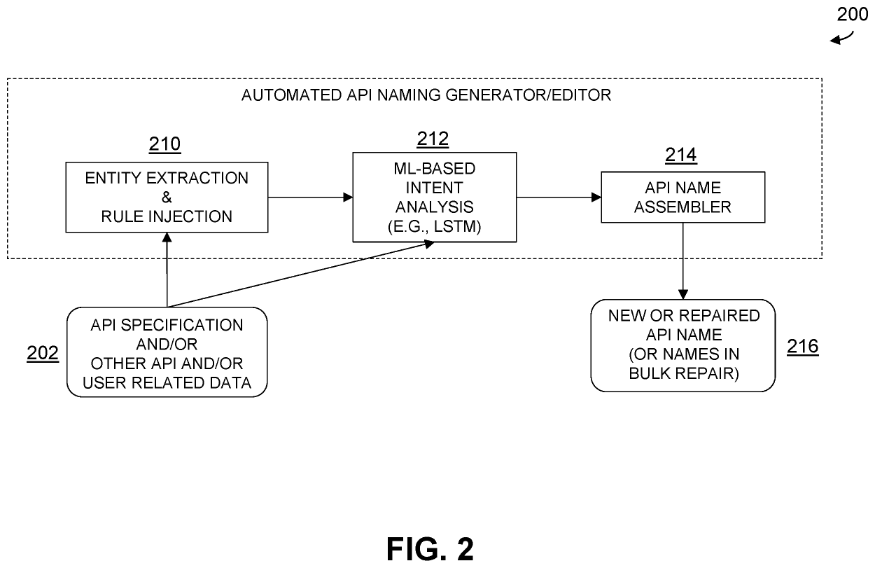

Referring now to FIG. 2, an architecture 200 is depicted for an automated application programming interface naming generator/editor according to an illustrative embodiment. Architecture 200 may be considered one illustrative embodiment of an architecture for automated API naming generator/editor 112 of FIG. 1. More particularly, as shown, architecture 200 comprises a set of modules including an entity extraction and rule injection module 210, a machine learning (ML)-based intent analysis module 212, and an API name assembler module 214. As will be explained in further detail, based on input comprising an API specification and/or other API and/or user related data 202, architecture 200 generates and outputs a new or repaired API name 216.

Entity extraction and rule injection module 210 receives or otherwise obtains API specification and/or other API and/or user related data 202. In one or more illustrative embodiments, entity extraction and rule injection module 210 utilizes named entity recognition (NER) or other natural language processing (NLP) to extract relevant terms from API specification and/or other API and/or user related data 202. A NER algorithm is configured to locate named entities mentioned in unstructured text and classify them into pre-defined categories. Some available NER platforms include GATE, OpenNLP, SpaCy, and Transformers. However, embodiments of entity extraction and rule injection module 210 are not intended to be limited to any specific NER algorithm or platform.

By way of example only, assume that a given API specification provided by a developer to entity extraction and rule injection module 210 comprises the following partial description:

“Dell VxRail is a fully integrated, pre-configured, and pre-tested VMware hyperconverged system delivering virtualization, compute, and storage all in one appliance. This guide describes the API for VxRail, including VxRail software versions 4.5.x, 4.7.x, 7.0.x, and 8.0.x. The target audience for this guide includes customers, field personnel, and partners who want to manage and operate VxRail clusters using the VxRail API . . . ”

Following application of an NER algorithm, assume that entity extraction and rule injection module 210 returns the following named entities: “Dell VxRail,” “VxRail,” “VxRail API,” and “Dell.” Entity extraction and rule injection module 210 then performs rule injection on the returned named entities by filtering the returned named entities via one or more predefined rules that specify, by way of example only, removing generic names such as “Dell,” removing offensive, derogatory or other predetermined words, and preventing exclusive language. Following rule injection, assume that entity extraction and rule injection module 210 returns the following named entity: “VxRail API.”

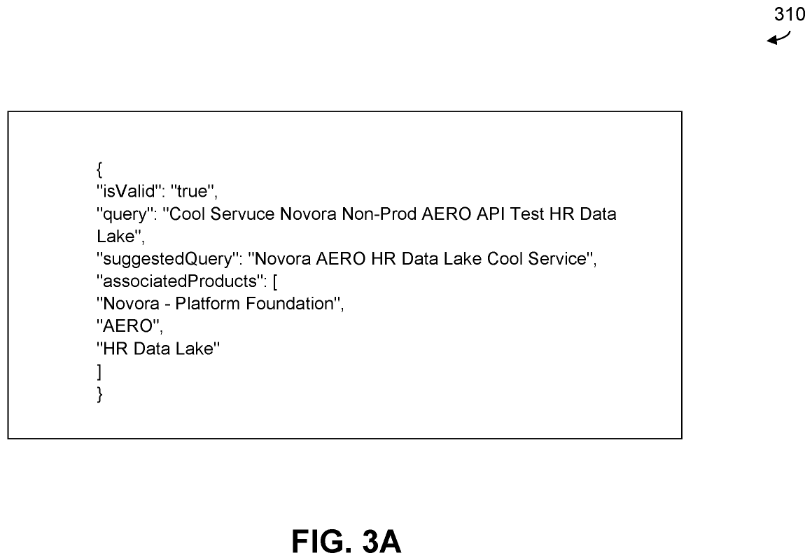

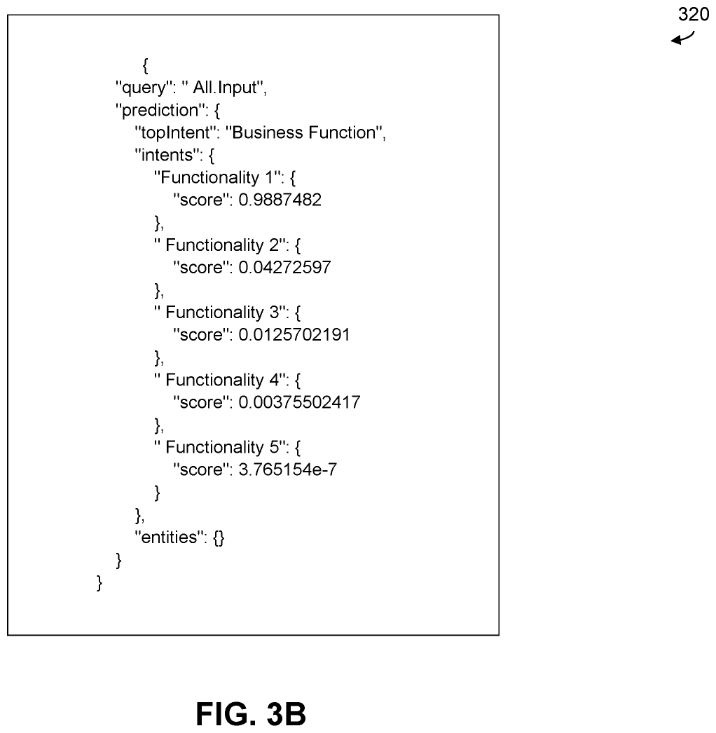

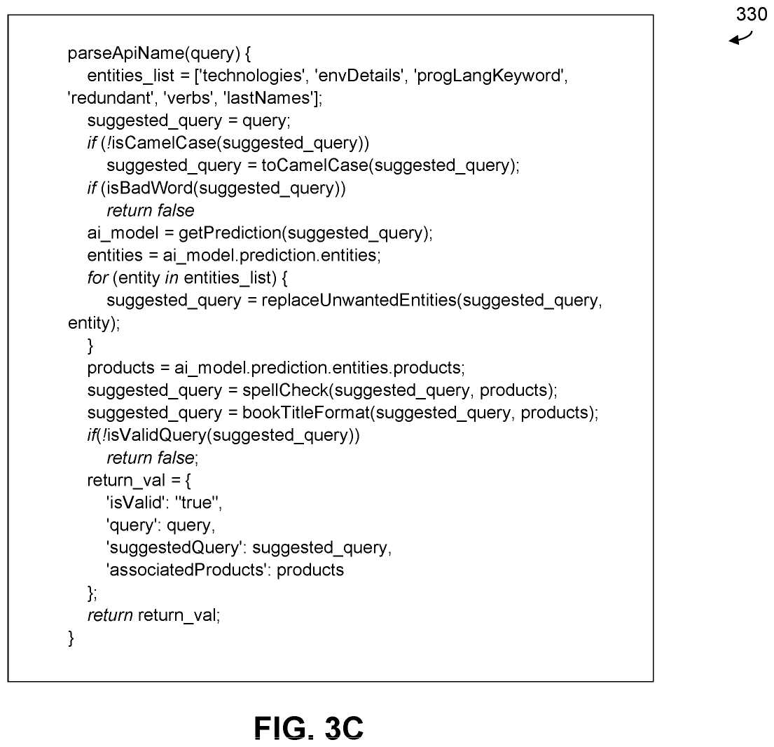

By way of further example, FIG. 3A illustrates exemplary program code 310 with another non-limiting example of rule injection that can be applied by entity extraction and rule injection module 210. It is to be appreciated that, in some embodiments, entity extraction and rule injection module 210 may be implemented by one or more trainable ML models that perform the entity extraction and rule injection functionalities described herein.

ML-based intent analysis module 212 also receives or otherwise obtains API specification and/or other API and/or user related data 202, as well as the named entity output by entity extraction and rule injection module 210. ML-based intent analysis module 212 is configured to apply intent detection and analysis on at least a portion of the information it receives. In some embodiments, ML-based intent analysis module 212 can implement an ML model (custom-developed model or a trained generic model) for finding the relevancy and intent (e.g., business or other function) of an API. The ML model can take inputs from various metadata sources such as API specifications and/or other API documentation, the publisher's organization domain, enterprise API naming standards, and any other organizational or enterprise data sources (e.g., GitLab, LeanIX, etc.). The ML model can be further enhanced to provide additional capabilities such as, for example, API description and others.

In some embodiments, the ML model uses Long Short-Term Memory (LSTM) network techniques. An LSTM network is a recurrent neural network (RNN) configured to learn long-term dependencies especially in sequence prediction problems such as, for example, problems involving classification, processing and predicting data based on time series. An exemplary LSTM unit comprises a cell, an input gate, an output gate, and a forget gate. The cell remembers values over arbitrary time intervals and the input, output, and forget gates regulate the flow of information into and out of the cell. Forget gates decide which information to discard from a previous state by assigning to a previous state, compared to a current input, a value between 0 and 1. A value of 1 means to keep the information, and a value of 0 means to discard it. Input gates decide which new information to store in the current state, using the same system as forget gates. Output gates control which information in the current state to output by assigning a value from 0 to 1 to the information, considering the previous and current states. Selectively outputting relevant information from the current state allows the LSTM network to maintain useful, long-term dependencies to make predictions, both in current and future time-steps. However, it is to be appreciated that ML-based intent analysis module 212 is not intended to be limited to any specific intent detection and analysis models.

Following application of the LSTM or other ML model techniques, assume that ML-based intent analysis module 212 returns an intent result of “Manage.” More particularly, the specific intent result means that ML-based intent analysis module 212 predicted that management of some named entity is the intention of the API specification and/or other API and/or user related data 202 that it analyzed. Recall, as explained above, that entity extraction and rule injection module 210 returned the following named entity: “VxRail API.” Thus, ML-based intent analysis module 212 is predicting that the intent of the data it received and analyzed is to describe management of the VxRail API.

By way of further example, FIG. 3B illustrates exemplary program code 320 with another non-limiting example of intent (or sentiment) detection and classification that can be applied by ML-based intent analysis module 212.

API name assembler module 214 aggregates and assembles the outputs from entity extraction and rule injection module 210, i.e., “VxRail API,” and ML-based intent analysis module 212, i.e., “Manage,” to create one single output based on the API specification and/or other API and/or user related data 202 received by architecture 200, i.e., “Manage VxRail API.” This output thus represents the suggested API name corresponding to the API specification and/or other API and/or user related data 202. “Manage VxRail API” is an example of the above-mentioned <Capability/Functionality Name> <Product Name> <Enterprise Domain> standardized format, wherein “Manage” is the capability/functionality part of name, “VxRail” is the product name part of the name, and “API” is the enterprise domain part of the name. Of course, names generated by architecture 200 can take on other standardized formats.

By way of further example, FIG. 3C illustrates exemplary program code 330 with another non-limiting example of name assembly that can be applied by API name assembler module 214.

As mentioned, architecture 200 can also be used to edit or repair names for existing APIs to have the standardized format. In such case, it is assumed that API specification and/or other API and/or user related data 202 also comprises behavioral data collected for the subject API and/or behavioral data collected from the one or more users with respect to the subject API 106. For example, architecture 200 can obtain data from API developer portal 102 that reflects problems a user may have had with searching and/or accessing an existing API. This behavioral data, along with some or all of the data (202) mentioned above, can be presented to entity extraction and rule injection module 210 and ML-based intent analysis module 212 such that API name assembler module 214 can output an edited (repaired) name that is clearer, less ambiguous, or otherwise more correct, and that is more reflective of the API's purpose. In some embodiments, more than one API name can be simultaneously or contemporaneously repaired by architecture 200 and republished to API developer portal 102. By way of example only, assume that there are multiple APIs that exist for the same product name. As such, architecture 200 can perform entity extraction, rule injection, intent detection and analysis, and name assembly for each of the multiple APIs for the given product in bulk.

Advantageously, as explained herein, architecture 200 adapts AI/ML solutions to train patterns that, inter alia: (i) use entity extraction such as a NER method to filter names out of a large data set; (ii) apply filters such as ones configured to prevent offensive/exclusive/derogatory language; (iii) perform intent detection and classification to understand the context (e.g., business or other functional context) using the subject API descriptions and/or documentation; (iv) apply API standards at the organizational level and domain level (e.g., based on API owner's name, product model, and/or business domain); (v) continuously update the ML models; and (vi) provide API name suggestions.

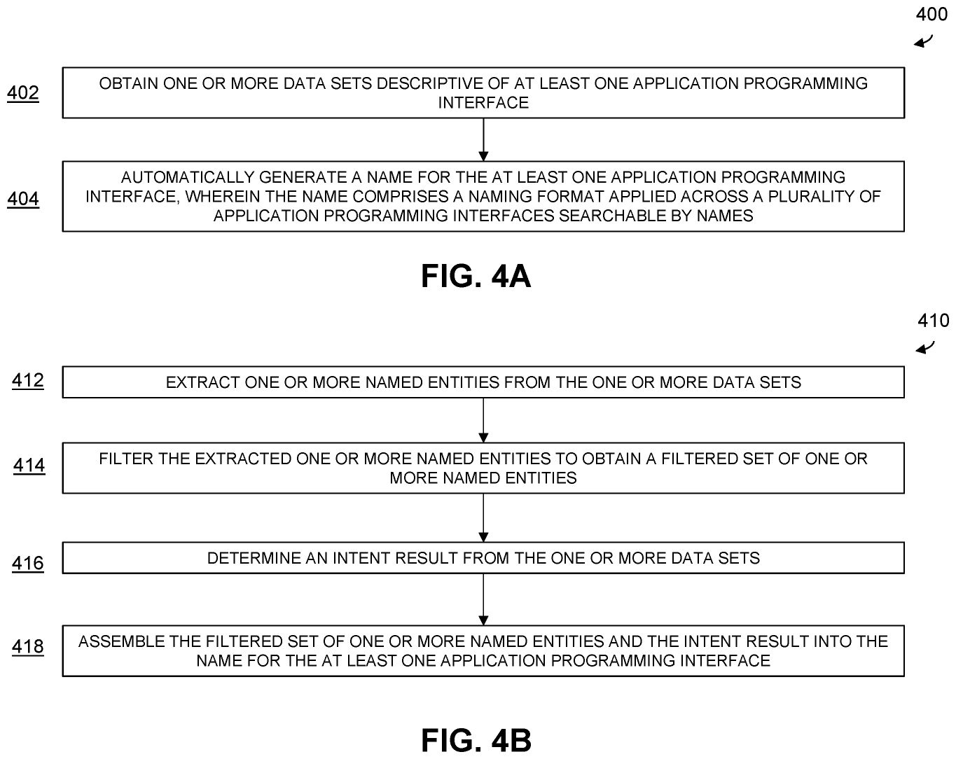

FIGS. 4A and 4B illustrate automated application programming interface name generation/edit methodologies 400 and 410, respectively, according to illustrative embodiments.

As shown in FIG. 4A, automated application programming interface name generation/edit methodology 400 comprises step 402 which obtains one or more data sets descriptive of at least one application programming interface, and step 404 which automatically generates a name for the at least one application programming interface, wherein the name comprises a naming format applied across a plurality of application programming interfaces searchable by names.

As shown in FIG. 4B, automated application programming interface name generation/edit methodology 410 performs automatic generation of a name for at least one application programming interface via the following steps. Step 412 extracts one or more named entities from the one or more data sets. Step 414 filters the extracted one or more named entities to obtain a filtered set of one or more named entities. Step 416 determines an intent result from the one or more data sets. Step 418 assembles the filtered set of one or more named entities and the intent result into the name for the at least one application programming interface.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

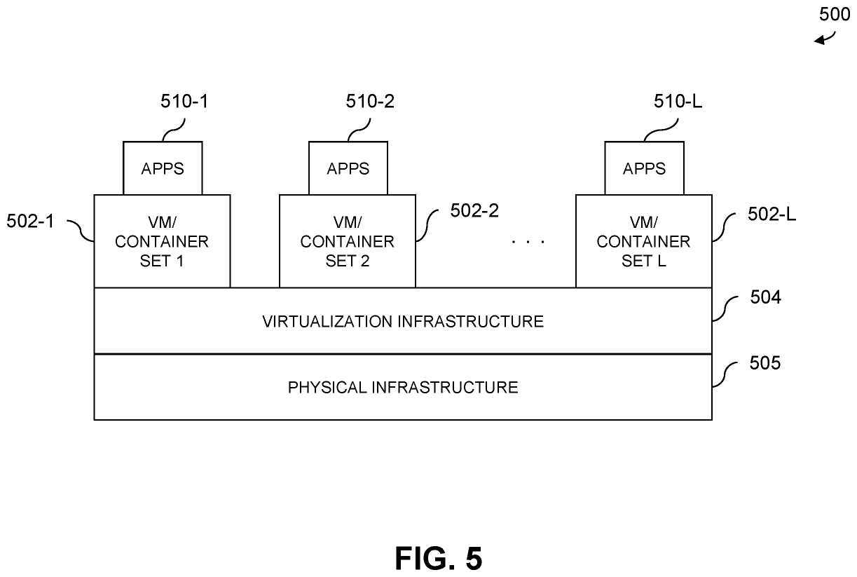

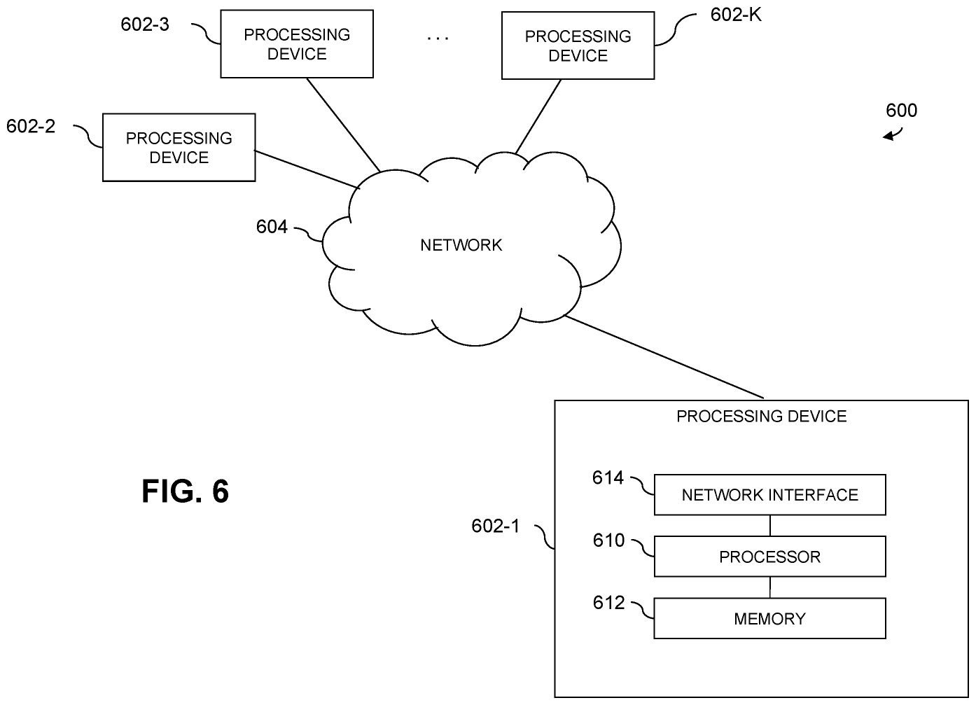

Illustrative embodiments of processing platforms utilized to implement functionality for application program management using an application assistant will now be described in greater detail with reference to FIGS. 5 and 6. Although described in the context of the information processing system environment mentioned herein, these platforms may also be used to implement at least portions of other information processing systems in other embodiments.

FIG. 5 shows an example processing platform comprising infrastructure 500. Infrastructure 500 comprises a combination of physical and virtual processing resources that may be utilized to implement at least a portion of the information processing system environment 100 in FIG. 1. Infrastructure 500 comprises multiple virtual machines (VMs) and/or container sets 502-1, 502-2, . . . 502-L implemented using virtualization infrastructure 504. The virtualization infrastructure 504 runs on physical infrastructure 505, and illustratively comprises one or more hypervisors and/or operating system level virtualization infrastructure. The operating system level virtualization infrastructure illustratively comprises kernel control groups of a Linux operating system or other type of operating system.

Infrastructure 500 further comprises sets of applications 510-1, 510-2, . . . 510-L running on respective ones of the VMs/container sets 502-1, 502-2, . . . 502-L under the control of the virtualization infrastructure 504. The VMs/container sets 502 may comprise respective VMs, respective sets of one or more containers, or respective sets of one or more containers running in VMs.

In some implementations of the FIG. 5 embodiment, the VMs/container sets 502 comprise respective VMs implemented using virtualization infrastructure 504 that comprises at least one hypervisor. A hypervisor platform may be used to implement a hypervisor within the virtualization infrastructure 504, where the hypervisor platform has an associated virtual infrastructure management system. The underlying physical machines may comprise one or more distributed processing platforms that include one or more storage systems.

In other implementations of the FIG. 5 embodiment, the VMs/container sets 502 comprise respective containers implemented using virtualization infrastructure 504 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of information processing system environments mentioned herein may each run on a computer, server, storage device or other processing platform element. A given such element may be viewed as an example of what is more generally referred to herein as a “processing device.” Infrastructure 500 shown in FIG. 5 may represent at least a portion of one processing platform. Another example of such a processing platform is processing platform 600 shown in FIG. 6.

The processing platform 600 in this embodiment comprises at least a portion of information processing system environment 100 and includes a plurality of processing devices, denoted 602-1, 602-2, 602-3, . . . 602-K, which communicate with one another over a network 604.

The network 604 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 602-1 in the processing platform 600 comprises a processor 610 coupled to a memory 612.

The processor 610 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU) or other type of processing circuitry, as well as portions or combinations of such circuitry elements.

The memory 612 may comprise random access memory (RAM), read-only memory (ROM), flash memory or other types of memory, in any combination. The memory 612 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 602-1 is network interface circuitry 614, which is used to interface the processing device with the network 604 and other system components, and may comprise conventional transceivers.

The other processing devices 602 of the processing platform 600 are assumed to be configured in a manner similar to that shown for processing device 602-1 in the figure.

Again, the particular processing platform 600 shown in the figure is presented by way of example only, and information processing system environments mentioned herein may include additional or alternative processing platforms, as well as numerous distinct processing platforms in any combination, with each such platform comprising one or more computers, servers, storage devices or other processing devices. For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality for application monitoring with predictive anomaly detection and fault isolation as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, edge computing environments, applications, etc. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method comprising:
obtaining one or more data sets descriptive of at least one application programming interface; and
automatically generating a name for the at least one application programming interface, wherein the name comprises a naming format applied across a plurality of application programming interfaces searchable by names;
wherein the steps are performed in accordance with a processing device comprising a processor operatively coupled to a memory and configured to execute program code.

2. The method of claim 1, further comprising publishing the generated name to a portal for searching for the plurality of application programming interfaces.

3. The method of claim 2, wherein the at least one application programming interface is an additional application programming interface to be searchable in the portal based on the generated name.

4. The method of claim 2, wherein the at least one application programming interface is an existing application programming interface to be searchable in the portal based on the generated name.

5. The method of claim 1, wherein the one or more data sets are descriptive of multiple application programming interfaces such that names are automatically generated for the multiple application programming interfaces.

6. The method of claim 1, wherein automatically generating a name for the at least one application programming interface further comprises extracting one or more named entities from the one or more data sets.

7. The method of claim 6, wherein extracting one or more named entities from the one or more data sets further comprises utilizing a named entity recognition algorithm.

8. The method of claim 6, wherein automatically generating a name for the at least one application programming interface further comprises filtering the extracted one or more named entities to obtain a filtered set of one or more named entities.

9. The method of claim 8, wherein filtering the extracted one or more named entities to obtain a filtered set of one or more named entities further comprises applying one or more rules to remove one or more predefined terms from the extracted one or more named entities.

10. The method of claim 8, wherein the extracting and filtering are implemented via one or more machine learning models.

11. The method of claim 8, wherein automatically generating a name for the at least one application programming interface further comprises determining an intent result from the one or more data sets.

12. The method of claim 11, wherein determining an intent result from the one or more data sets further comprises utilizing a long short-term memory network.

13. The method of claim 11, wherein the intent result determining is implemented via one or more machine learning models.

14. The method of claim 11, wherein automatically generating a name for the at least one application programming interface further comprises assembling the filtered set of one or more named entities and the intent result into the name for the at least one application programming interface.

15. The method of claim 1, wherein the naming format comprises one or more of a functionality part, a product part, and a functional domain part.

16. An apparatus comprising:
at least one processing platform comprising at least one processor coupled to at least one memory, configured to:
obtain one or more data sets descriptive of at least one application programming interface; and
automatically generate a name for the at least one application programming interface, wherein the name comprises a naming format applied across a plurality of application programming interfaces searchable by names.

17. The apparatus of claim 16, wherein the at least one processing platform is further configured to automatically generate a name for the at least one application programming interface by extracting one or more named entities from the one or more data sets, and filtering the extracted one or more named entities to obtain a filtered set of one or more named entities.

18. The apparatus of claim 17, wherein the at least one processing platform is further configured to automatically generate a name for the at least one application programming interface by determining an intent result from the one or more data sets.

19. The apparatus of claim 18, wherein the at least one processing platform is further configured to automatically generate a name for the at least one application programming interface by assembling the filtered set of one or more named entities and the intent result into the name for the at least one application programming interface.

20. A computer program product comprising a non-transitory processor-readable storage medium having stored therein program code of one or more software programs, wherein the program code when executed by at least one processing device causes the at least one processing device to:
obtain one or more data sets descriptive of at least one application programming interface; and
automatically generate a name for the at least one application programming interface, wherein the name comprises a naming format applied across a plurality of application programming interfaces searchable by names in a portal.
